(19) United States
(12) Patent Application Publication
(10) Pub. No.: US 2005/0096983 A1
(43) Pub. Date: May 5, 2005

(54) Internet advertising system

(75) Inventor: Richard John Werkhoven, Strathfield (AU)

Correspondence Address: FOLEY AND LARDNER;SUITE 500, 3000 K STREET NW, WASHINGTON, DC, 20007, US

(73) Assignee: CREATIVE EDGE INTERNET SERVICES PTY. LTD.

(21) Appl. No.: 11/006,659

(22) Filed: Dec. 8, 2004

Related U.S. Application Data
(63) Continuation of application No. 10/211,245, filed on Aug. 5, 2002, now abandoned.
Application No. 10/211,245 is a continuation of application No. 09/700,205, filed on Jan. 22, 2001, now abandoned.

(30) Foreign Application Priority Data
May 11, 1998 (AU) PP3473

(51) Int. Cl. G06F 17/60

(52) U.S. Cl. 705/14

(57) ABSTRACT

In a computer user interface environment for display of information, a method of providing push content, such as an advertisement, provides a pop-up window after a user has viewed first predetermined information for a predetermined time. For example, the user may be viewing a web page, and the pop-up window will be provided a predetermined time after the user has begun viewing the web page. The pop-up window having a push content is played separately from the web page so that if a user moves from web page to web page throughout a site, the pop-up window will continue playing the push content.

### FIELD OF THE INVENTION

The present invention relates to the utilization and delivery of content when utilizing a user interface on a computer and has application to advertising over the Internet as well as other forms of content delivery.

### BACKGROUND OF THE INVENTION

Recently, society has seen an explosion in the utilization of the Internet and other similar computer networks for the conveyancing information. In particular, the “World Wide Web”, has provided for the cataloguing and accessing of almost an infinite amount of information.

While web pages were originally a vehicle limited to placing text on a screen on remote computers, web pages have effectively become a receptacle for sound, pictures, animations and a form of video, amongst other forms of information.

Further, recently, the World Wide Web has experienced a high degree of commercialization. It is now common to provide for advertising over the World Wide Web. Within any advertising program, one objective is to ensure the advertising is effective in placing the message before the viewer. Hence, the placement of appropriate advertising with certain Internet sites has grown up as a separate Internet industry with the resulting revenue from advertising often driving the production of web pages. Of course, with such developments as the convergence of the Internet with interactive television and the further convergence with computer operating systems, the utilization of advertising is becoming more important generally within such computer systems.

Despite innovations in Internet-related technology, there is often a significant delay between content being requested by a user from a provider and that requested information being displayed on the computer screen which can result in such requests being cancelled by users before the content can be displayed. One consequence of this for advertising is that many users fail to view the intended advertisements. The delay is often due to the bandwidth limitations of delivery. In practice, users are very sensitive to waiting for extended periods for content delivery.

Another shortcoming with existing form of Internet-based advertising is that, due to limitations of existing browsers and code in use, there is no way for the advertiser to determine if the user had closed the window containing the advertisement before the advertisement could complete its presentation.

### SUMMARY OF THE INVENTION

It is an object of the present invention to provide for improved content delivery capabilities with interactive computer systems and to enable the measurement of completion of that content being displayed on a user's computer screen.

In accordance with a first aspect of the present invention, there is provided in a computer user interface environment for the display of information, a method of providing push content to a user comprising the step of: (a) automatically displaying a pop-up window displaying the push content material, the pop-up window being provided a predetermined time after a user has begun viewing first predetermined information.

The push content can be separately loaded over a network whilst the user can be viewing the first predetermined information. Preferably, the popup window disappears after a second predetermined interval. The method can further include the step of iterating step (a) after a third predetermined time interval.

The user interface can comprise an Internet browser and the information can be stored at an Internet site. Preferably, the method continues with the step (a) whilst a user visits pages within the Internet site.

The push content can be specific to the browser utilized by the user. The method can be implement through the utilization of a scripting language of the browser. The predetermined information can be varied in accordance with the time of access by the user.

In accordance with a further aspect of the present invention, there is provided in a computer user interface environment for the display of information, a method of providing push content delivery comprising the steps of: (a) providing a popup window having a determined content, the popup window being provided after a predetermined time a user viewing predetermined information, the pop up window further displaying second predetermined information; and (b) recording whether the popup window was closed by the user prior to completion of second interval and the display of the determined portion of content was completed. (c) closing or repositioning the popup window at the back of other windows after a third interval.

Preferably, the method further comprises iterating steps (a) to (c) after a fourth interval. The push content can further be varied in accordance with parameters available to the programming or scripting language used in a particular implementation of the method. The push content can be varied in accordance with a detected IP address of the user.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates a basic flow chart for the steps of the preferred embodiment.

### DESCRIPTION OF PREFERRED AND OTHER EMBODIMENTS

The preferred embodiment consists of a series of, or individual interactive web sites which deliver “popup” content to users visiting the World Wide Web page. These Web pages can be encoded utilizing standard HTML and Java Script encodings although it will be readily apparent to those skilled in the art that the present invention is readily applicable to many other language formats.

Preferably, this system delivers a predetermined portion of the content within a “popup” window which is provided for a predetermined time and then removed from the user's screen. The time is preferably set for each individual predetermined portion of the content and the software then waits for a predetermined period of time before running the next determined portion of content, even if a user switches pages within a site. If a user leaves the site completely, then the system is unable to run another portion of content until the visitor returns to the site. In any event, preferably the system does not run the next determined portion of content until the necessary time has passed since the last determined portion of content. The preferred embodiment can be implemented utilizing a browser scripting language such as JavaScript and preferably waits before beginning to load the determined portion of content until after the main page has finished loading. This is more reliable than loading the page and determined portion of content simultaneously, and ensures that the site itself loads without interruption. This can, of course, be configured for each page/frameset running the software.

The software checks the version of the browser the visitor is using. If the browser supports it, the determined portion of content will be loaded into a window while it is in the background and then moved to the foreground, otherwise it will be loaded in the foreground.

The user is able to switch windows or close the window containing the determined portion of content, thereby skipping that particular determined portion of content—although the next determined portion of content in the sequence will still run. If the window is not closed by the user before a given determined portion of content has been completely displayed on the user's screen, then a record of that completion can be added to a tally recorded in a predetermined file.

The runtime of each determined portion of content is determined by the determined portion of content itself—this allows for more flexibility in the design of the content to be delivered and the ability for the determined portions of content to change their length depending on circumstances.

The sequence of determined portions of content and the timing of the gaps between them can be determined by a playlist.

The playlist for the determined portions of content along with the code to run them must currently be included in each page that the determined portions of content are to run from. This either has to be auto-inserted by the server or added to the content of each page.

The only exception to this is framed sites, where the code & playlist can be run from the page declaring the frameset and will then apply to all pages in the frameset.

As an alternative, it would be possible for the code and playlist to reside in separate files that are referenced from the pages requiring them, but this part of JavaScript is not supported by some versions of Internet Explorer currently in use. This situation will change as users move to newer versions of browsers.

This method of insertion is likely to reduce site management overhead as well as reduce the effective size of the code for each page, and the JavaScript and playlist is likely to be cached separately by the user's browser as well as by the proxy service they are using.

This system is preferable to any system which opens an empty window every time a user attempts to view the top level (home page) of a site before loading the determined portion of content and remains on screen until closed by the visitor—this either results in the user closing the window before the determined portion of content has finished loading, or multiple windows are left on the screen all showing the same determined portion of content.

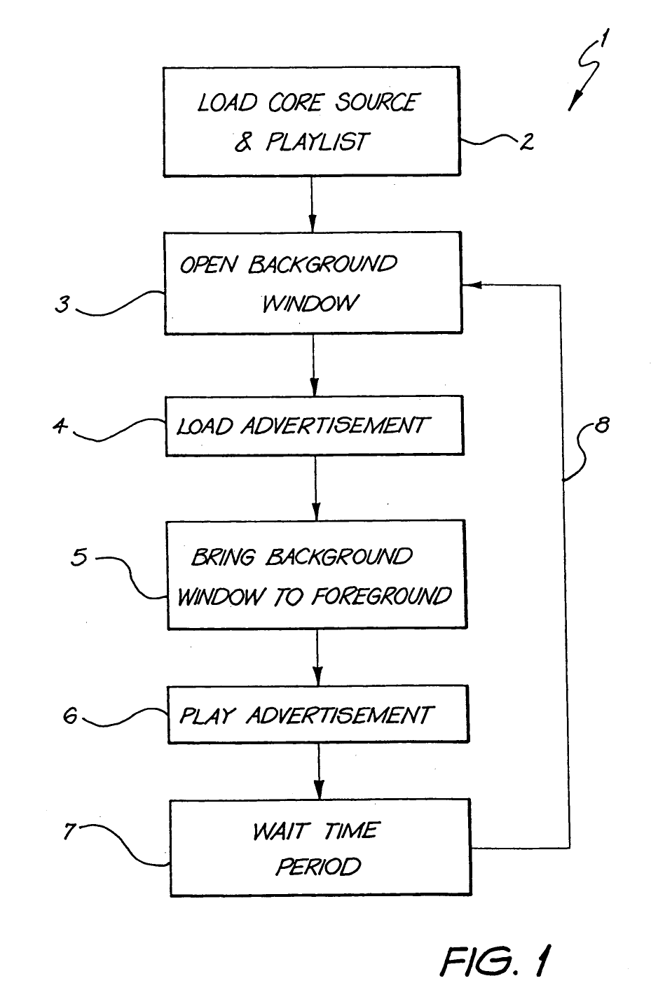

Turning now to FIG. 1, there is illustrated a basic example flow chart of this steps 1 of the preferred embodiment. Initially, when a user opens a Web Page at a site, the poor information for that Web Page is downloaded 2 in addition to a playlist of popup advertisements.

Next, HTML code is instructed to open a background window and the advertisement is loaded from its relevant HTML source 4. Upon loading, the add is brought to the foreground 5 and “played” 6. Subsequently, a time period lapses 7 and the method of the preferred embodiment iterates 8 back to the step 3.

Whilst an actual example of the relevant HTML encoding is provided in the attached appendix A, a number of general parts of this code will now be described.

To start the sequencer the following is added to the html<BODY>tag.

```
<BODY onLoad - “startNetBreak( )”>
Playlist
  The playlist can be in the following format
  //Playlist Start
  Array Declarations
  itemURL [0] = “URL of first item”
  itemWait [0] = seconds before first item
  itemSize [0] = “width=width in pixels of first item,
height = height in pixels of first ad”
  itemURL [1] = “URL of item 2”
  itemWait [1] = seconds before item 2
  itemSize [1] = “width=width in pixels ad 2.
height=height in pixels of item 2”
.............................. .
  itemURL [n−1] = “URL of item n”
  itemWait [n−1] = seconds before item n
  itemSize [n−1] = “width=width in pixels item n.
height=height in pixels and item n”
  // Playlist End
Here is a sample playlist for determined portions of
content.
  //Playlist Start
  var itemURL = new Array (2)
  var itemWait = new Array (2)
  var itemSize = new Array (2)
  itemURL [0] =
http://netbreak.com.au/Popups/EdgeLogoSeq.html”
  itemWait [0] =60
  itemSize [0] = “width=620, height=420”
  itemURL [1] = “http://
  netbreak.com.au/Popups/PromoTester.html”
  itemWait [1] = 60
  itemSize [1] = “width=200, height=150”
  // Playlist End
```

There are a number of different methods of implementing this system on a web site. The implementation can be dependent on the way the web site is being served and the capabilities of the web server in use.

1. Live Database Generated Web Pages

The database system generating the pages would insert the JavaScript and Playlist into the required pages as the pages are generated.

This would only require modification one file when the playlist is changed and the page content would then be updated for all new pages generated.

2. Scriptable Web Server

The web server could automatically insert the JavaScript and Playlist into the required pages as it is serving the pages.

This option would also require only one change when the playlist is changed.

3. Straight Web Serving—No Server Programming

The JavaScript and Playlist block can be inserted into the pages by editing the HTML file for each page.

This would require each page to be edited when the playlist is changed.

The system is preferably capable of running any content that can be handled by the browser, as it can display the determined content by loading a URL into the popup window. The content can be responsible for bringing itself to the front when loaded.

The window is closed when the content signals to the originating window that it has finished. Therefore for the window to go away automatically requires the insertion of a small JavaScript to send this message and also requires a call to tell this script when to do so.

As a result of this, although any URL can be used it may be necessary to add JavaScript to each determined portion of content so that it presents correctly.

A variety of further refinements can be implemented in certain configurations. These include firstly that the JavaScript code, when used, can be created to selectively load contents based on the capabilities of the user's browser and plug-ins, enabling the use of plug-in dependent content where possible and at the same time ensuring content delivery by delivering an alternate version where necessary. An example of such a Browser capability change is given in the Appendix Example.

In a second refinement the selective content ability can also be used to target content specifically for the user, as long as the necessary information is available to the browser. This feature can tie in with information based on what pages the user has visited or on forms data collected by adding JavaScript to the pages collecting the data. This could also be used to advertise browsers or plug-ins for example, depending on what the user already has—informing the user of an update, for example.

In a third refinement, the time interval for the display of the predetermined portion of content can be determined by rules encoded into the content being displayed. These rules can be dependent upon such parameters as mouse clicks, keyboard events, the type of browser user by the user, the hardware used by the user and any other parameters available to the programming or scripting language used in a particular implementation of this system.

In a fourth refinement, if another window (or windows) is (or are) brought in front of the popup window displaying the determined portion of content, the popup window will automatically return to the frontmost position after a predetermined portion of time. This can be implemented as part of playing an advertisement or as part of the playlist loop.

In a fifth refinement, where a further portion of content is to be delivered for display in a popup window that has completed the display of a determined portion of content, the popup window will automatically return to the rearmost position until the new portion of content is ready to be displayed in the popup window, after which the popup window will automatically return to the frontmost position and display the new portion of content.

In a sixth refinement, the popup window can be made to ‘popup’ on screen in the frontmost position at predetermined times of day and/or on predetermined dates.

In a seventh refinement, the predetermined portion of content can be determined by rules encoded into software residing on the file server management hardware providing the site implementing the system described in this document. These rules can be dependent upon such parameters as the type of browser user by the user, the hardware used by the user, the IP address of the device requesting the file.

In an eighth refinement, software residing on the file server management hardware providing the site implementing the system described in this document can determine the content according to the bandwidth available to the user, derived from information in the IP address or domain of the device requesting the file. This can be used to deliver larger file sizes or different media types to high-bandwidth connections.

In a ninth refinement, software residing on the file server management hardware providing the site implementing the system described in this document can determine the content according to the location of the user, derived from information in the IP address or domain of the device requesting the file. This can be used to deliver localized information such as local weather or specific-language information, for example.

In a tenth refinement, software residing on the file server management hardware providing the site implementing the system described in this document can, determine the content according to the user's domain-specific information, derived from information in the IP address or domain of the device requesting the file. This can be used to deliver domain-specific information such as educational information to educational sites (.edu) which uses information from the top level of the domain information, or advertising targeting users of a particular Internet service provider (.domain.com), which would use secondary as well as top level domain information, for example.

In an eleventh refinement, the popup window and the predetermined content can be subject to combinations of the abovementioned refinements.

Ideally the content used in the popup window should be kept to as few files as possible and should be able to load in about 30 seconds. At present standard modem bandwidth limits, this would probably mean a file size of about 150 Kb with modern computer modems (56 K) at most unless there is a good chance that a user will be on a page for more than long enough for the page to load.

Ideally the content to be displayed in the popup window should be small enough to fit a 640×480 pixel screen with menu bar, window frame, title bar and the extra space that the browser leaves from the left edge of the window. It is therefore suggested that the maximum size is 600(horizontal)×400(vertical) pixels to ensure good screen fit.

It is also desirable to use a standard size for all portions of content across a site—if not across all sites to ensure visitor comfort and reduce time taken for visitors to adjust to the appearance of the window. 540(horizontal)×405(vertical) pixels would provide a sufficient screen area for the advertisement while sitting comfortably within a 640(horizontal)×480(vertical) screen.

Of course, many modifications are possible. For example, the type of content used may be varied in accordance with the current time zone of the user. For example, different night time and day time content might be provided.

It would be appreciated by a person skilled in Internet-related technologies that numerous variations and/or modifications may be made to the present invention as shown in the specific embodiments without departing from the spirit or scope of the invention as broadly described. The present embodiments are, therefore, to be considered in all respects to be illustrative and not restrictive.

1. In a computer user interface environment for the display of information, a method of providing push content to a user comprising the step of:
(a) automatically displaying a pop-up window displaying the push content material, said pop-up window being provided a predetermined time after a user has begun viewing a first predetermined information, wherein said user interface comprises an Internet browser and said first predetermined information is stored at an Internet web site, and wherein said method continues with step (a) as the user visits pages within said Internet web site.

2. A method as claimed in claim 1, wherein said push content is separately loaded over a network whilst said user is viewing said first predetermined information.

3. A method as claimed in claim 1, wherein said window disappears after a second predetermined interval.

4. A method as claimed in claim 1, further comprising the step of iterating step (a) after a further predetermined time interval.

5. A method as claimed in claim 1, wherein said push content is specific to the browser utilized by said user.

6. A method as claimed in claim 1, wherein said method is implemented through the utilization of a scripting language of said browser.

7. A method as claimed in claim 1, wherein said predetermined information is varied in accordance with the time of access by said user.

8. In a computer user interface environment for the display of information, a method of providing push content delivery comprising the steps of:
(a) a computing system automatically providing a pop-up window having a predetermined push content, said pop-up window being provided after a first predetermined interval of a user viewing predetermined information from an Internet web site, said pop-up window further displaying second predetermined information;
(b) a computing system automatically recording whether the pop-up window was closed by the user prior to completion of a second interval and the display of a predetermined push content was completed; and
(c) a computing system automatically closing or repositioning said pop-up window at the back of other windows after a third interval,
wherein said steps (a) to (c) continue to be performed while the user visits pages within said Internet web site.

9. A method as claimed in claim 8, further comprising the step of iterating steps (a) to (c) after a fourth interval to provide further predetermined push content or a pop-up window.

10. (canceled)

11. A method as claimed in claim 1 wherein said push content is varied in accordance with a time of access by said user.

12. A method as claimed in claim 1, wherein said push content is varied in accordance with parameters available to a programming or scripting language used in a particular implementation of said method.

13. A method as claimed in claim 1, wherein said push content is varied in accordance with a detected IP address of said user.

14. A method as claimed in claim 8, wherein said push content is varied in accordance with a time of access by said user.

15. A method as claimed in claim 8, wherein said push content is varied in accordance with parameters available to a programming or scripting language used in a particular implementation of said method.

16. A method as claimed in claim 8, wherein said push content is varied in accordance with a detected IP address of said user.

17. A method as claimed in claim 4, wherein the push content comprises predetermined portions of push content, a predetermined portion of push content from the predetermined portions being displayed during each iteration of step (a).

18. A method in accordance with claim 17, wherein the sequence of the predetermined portions of content to display and the extent of the further predetermined time interval between iterations is determined in accordance with a playlist.

19. A method as claimed in claim 9, wherein the predetermined push content, further predetermined push content and the fourth interval are determined by a playlist.

20. A system for display of information including displaying push content to a user, comprising:
a computing system having a user interface configured to automatically display a pop-up window displaying the push content material, said pop-up window being provided a predetermined time after a user has begun viewing a first predetermined information from an internet web site, wherein said user interface comprises an Internet browser and said predetermined information is stored at said Internet web site, wherein said pop-up window continues to display push content while the user visits pages within said Internet web site.

21. The system according to claim 20, wherein the push content comprises predetermined portions of push content, and the predetermined portions of the push content are sequentially displayed in the pop-up window.

22. A system for display of information including displaying push content to a user, comprising:
a server computing system having a web server configured to automatically transmit to the user's computing system a playlist that displays the push content in a pop-up window at the user's computing system at a predetermined time after the user has begun viewing a first predetermined information from a web page stored at the web server, wherein said pop-up window continues to display push content while the user visits web pages within said web server.
